(19) United States
(12) Patent Application Publication
(10) Pub. No.: US 2004/0045389 A1
(43) Pub. Date: Mar. 11, 2004

(54) Rotating housing and gear assembly

(76) Inventor: David Mark Pascoe, Newmarket (CA)

Correspondence Address: Robin W. Asher, Clark Hill PLC, Suite 3500, 500 Woodward Avenue, Detroit, MI, 48226-3435, US

(21) Appl. No.: 10/430,445

(22) Filed: May 5, 2003

Related U.S. Application Data
(60) Provisional application No. 60/377,693, filed on May 3, 2002.

(51) Int. Cl. F16H 55/12

(52) U.S. Cl. 74/434; 74/447

(57) ABSTRACT

A housing and gear assembly comprises a cylindrical rotating housing having an inner cylindrical wall and a center bore for rotatably mounting the housing on an elongated shaft. An internal ring gear has a plurality of internal gear teeth, an external cylindrical wall and a plurality of spaced apart broach teeth projecting radially outwardly from the external wall for cutting engagement with the internal wall of the housing as the ring gear is press fit into the housing to fixedly and rotationally secure the ring gear to the housing.

### BACKGROUND OF THE INVENTION

1. Field of Invention

The subject invention relates to a rotating housing having a press fit internal gear.

2. Description of the Related Art

Automotive transmissions commonly include one way clutch assemblies having a gear housing rotatably coupled to a shaft. The rotating housing fixedly supports an internal ring gear for rotating the housing about the shaft. One way clutch rotating housing and internal ring gear assemblies are often made of a single steel component, typically manufactured by machining or flow forming a steel forging. Alternately, an internal ring gear is sometimes welded by laser, or electron beam, to a stamped, machined or flow formed housing. These methods of production are expensive and provide for a final product which is excessively heavy. Putting an internal spline on the housing and an external spline on the ring gear has been proposed and once the two parts are joined, a c-clip is used to prevent the ring gear from coming out of the housing. This solution has the draw back of being difficult to hold the ring gear tightly and in a precise location. In addition torque reversals can cause the ring gear to click against the housing causing an objectionable noise in some applications, for example in an automobile transmission.

There are basically three existing solutions to design the product. For example, FIGS. 1, 1a and 1b show an aluminum rotating housing 103 with a steel gear 104 and a c-clip 105. The housing 103 has an internal spline 114, which is either machined or produced by flow forming or stamping. The forged and machined or powder metal steel gear 104 has an external spline 115, which fits in the splined part of the aluminum rotating housing 103. A c-clip 105 holds the steel gear 104 in place. The splines of both the steel gear 104 and the aluminum housing 103 need to be manufactured within tight tolerances, and hence high cost, otherwise the gear 104 will slightly rotate in relation to the housing 103 when torque is applied and produce a clicking noise.

Another possibility to secure the position of the gear to the aluminum housing is shown in FIGS. 2, 2a and 2b. The aluminum housing 203 has various shaped stamped openings or slots 216 which are cast or machined into the wall of the housing 203. A steel gear 204 includes protrusions or castellations 217 of corresponding shape and position as the openings 216 in the housing 203. When the parts are assembled, the protrusions 217 will fit into the openings 216 of the housing 203 and torque can be transferred from the gear 204 to the housing 203. A c-clip 205 retains the gear 204 in the housing 203 and prevents the gear 204 from moving in the axial direction relative to the housing 203. But, if the protrusions 217 of the steel gear 204 or the openings 216 of the housing 203 are not manufactured within tight tolerances, the gear 204 will rotate slightly in relation to the housing 203 and produce a clicking noise once torque is applied thereto.

Finally, FIG. 3 shows yet another design approach of making the housing 303 and gear 304 in one piece out of steel. A one piece housing 303 can be flow formed or stamped, but typically needs extensive machining operations, particularly to form the gear teeth, which make it an expensive assembly. Also, since the one piece assembly is made entirely of steel, it will be heavier than a two piece aluminum housing and steel gear.

### SUMMARY OF THE INVENTION

According to one aspect of the invention there is provided a housing and gear assembly comprising a cylindrical housing having an inner cylindrical wall and a center bore for rotatably mounting the housing on an elongated shaft. An internal ring gear having a plurality of internal gear teeth, an external circumferential wall and a plurality of spaced apart broach teeth projecting radially outwardly from the external wall is provided for cutting engagement with the internal wall of the housing as the ring gear is press fit into the housing to fixedly and rotationally secure the ring gear to the housing. A c-clip is used as a safety retainer to prevent the ring gear from backing out of its installed or assembly position.

The resulting assembly is a light weight rotating housing and ring gear due to the cast aluminum housing. In addition, the ring gear is fixed tightly, accurately and permanently in position. Since the ring gear is the broach tool, the fit is tight and no clicking will occur between the ring gear and the housing during torque reversals. Finally, the assembly is inexpensive as the cast aluminum housing and ring gear can each be produced inexpensively and assembly is simple and can be done in a press machine.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a partial cross-sectional side view of a prior art rotating housing and internal ring gear;

FIG. 1a is a perspective view of the prior art ring gear of FIG. 1;

FIG. 1b is a perspective view of the prior art housing of FIG. 1;

FIG. 2 is partial cross-sectional side view of another prior art rotating housing and internal ring gear;

FIG. 2a is a perspective view of the ring gear of FIG. 2;

FIG. 2b is a perspective view of the housing of FIG. 2;

FIG. 3 is partial cross-sectional side view of yet another prior art one piece rotating housing and gear;

FIG. 4 is an end view of an internal ring gear press fit into a rotating housing according to one aspect of the subject invention;

FIG. 5 is a side view of the housing and gear assembly of FIG. 4;

FIG. 6 is a cross-sectional view taken along line A-A of FIG. 5;

FIG. 7 is a perspective view of the housing and gear assembly of FIG. 4; and

FIG. 8 is a partially exploded view of the housing and gear assembly of FIG. 7.

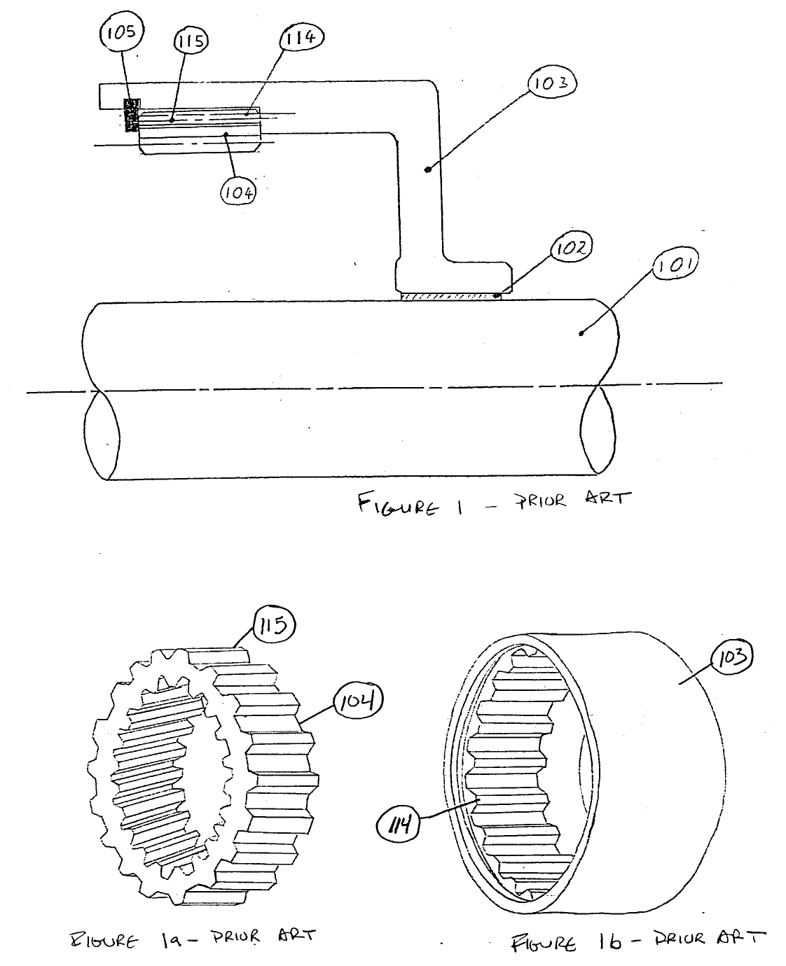

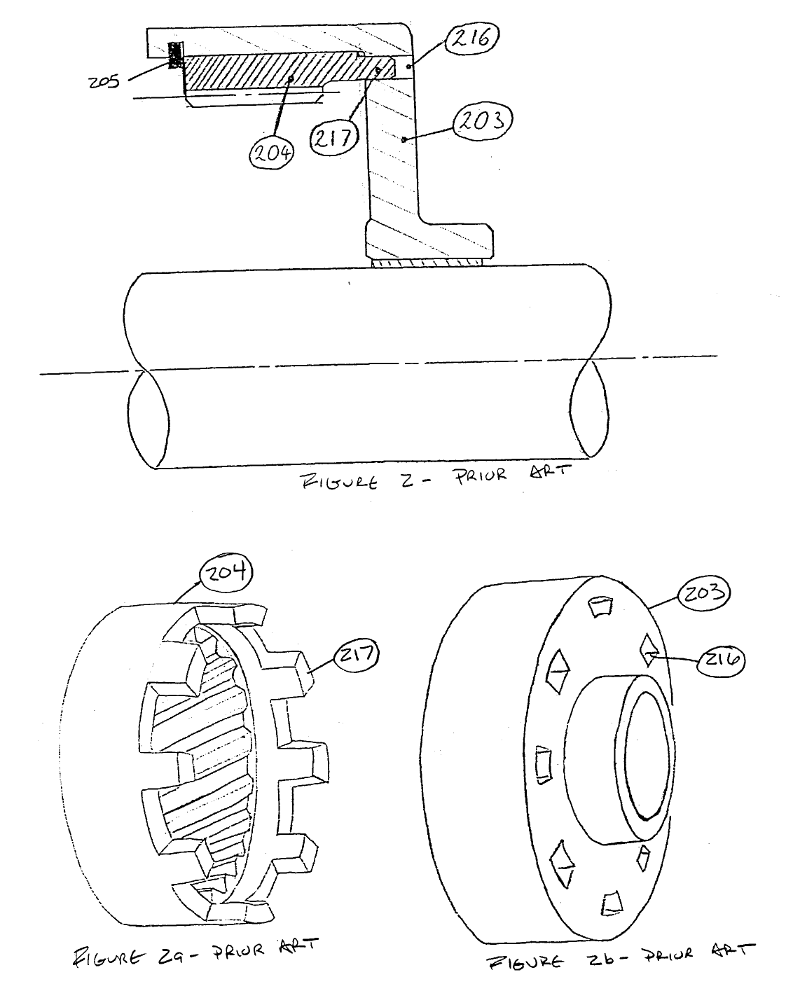

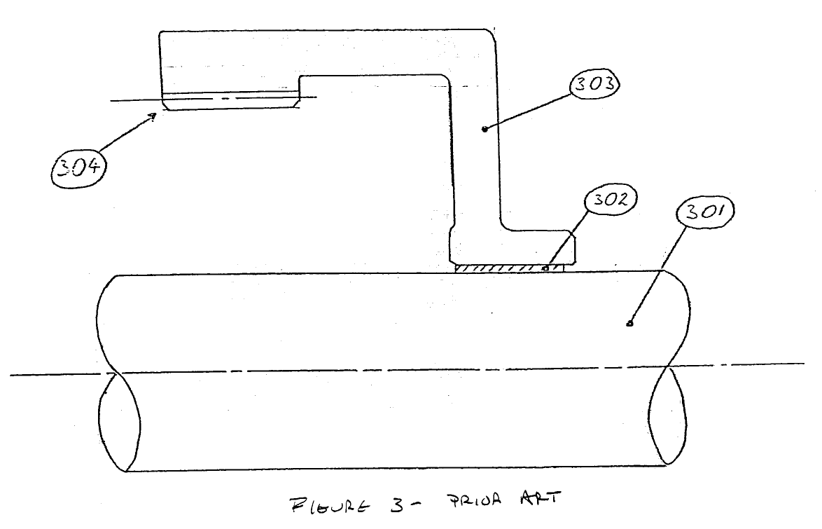

### DETAILED DESCRIPTION OF THE PREFERRED EMBODIMENT

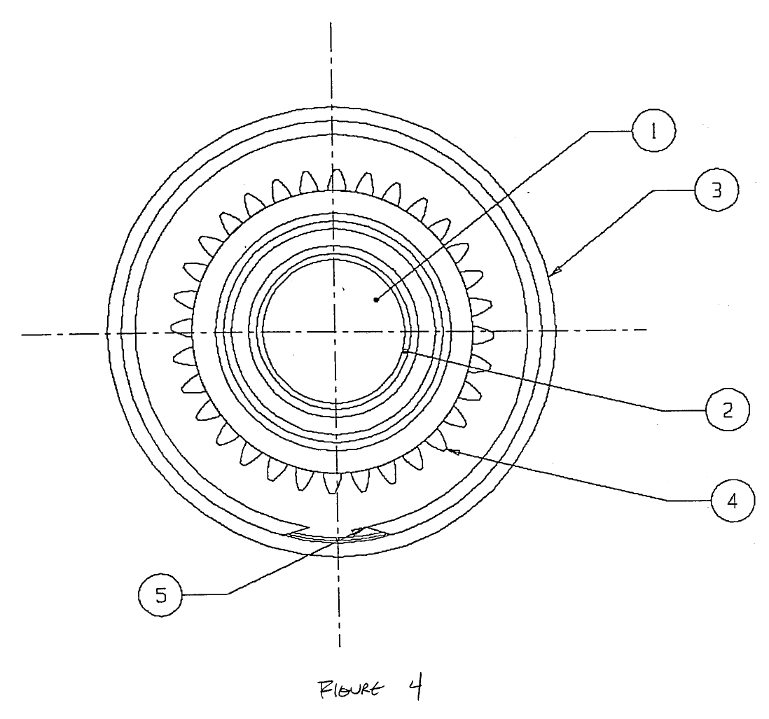

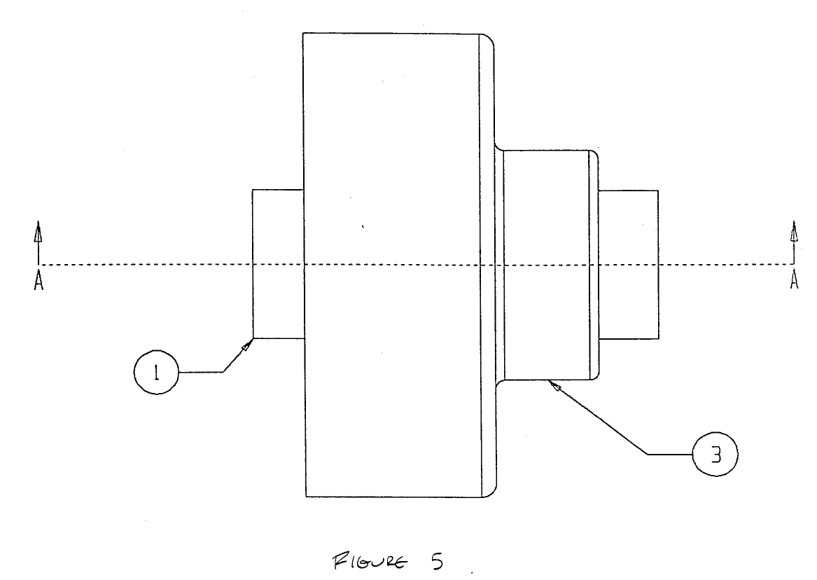

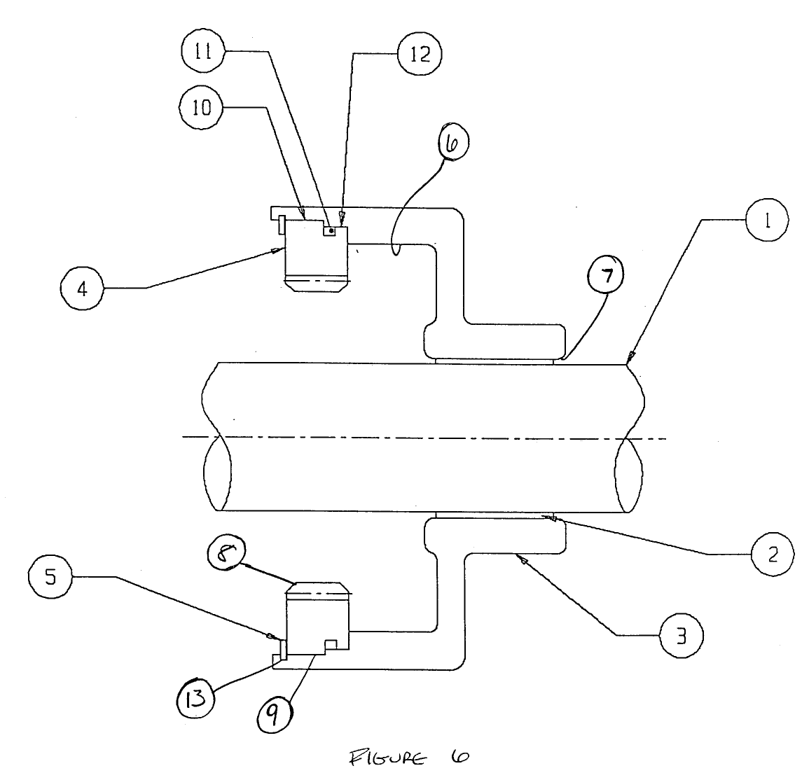

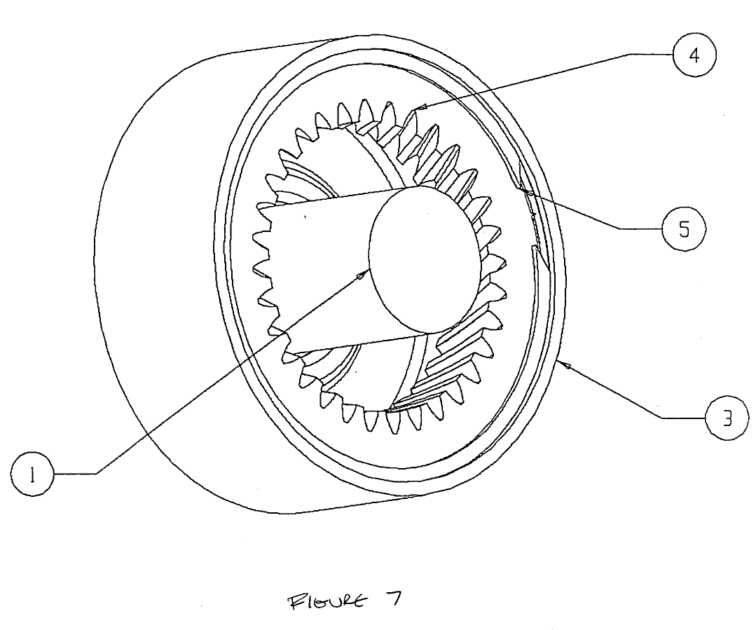

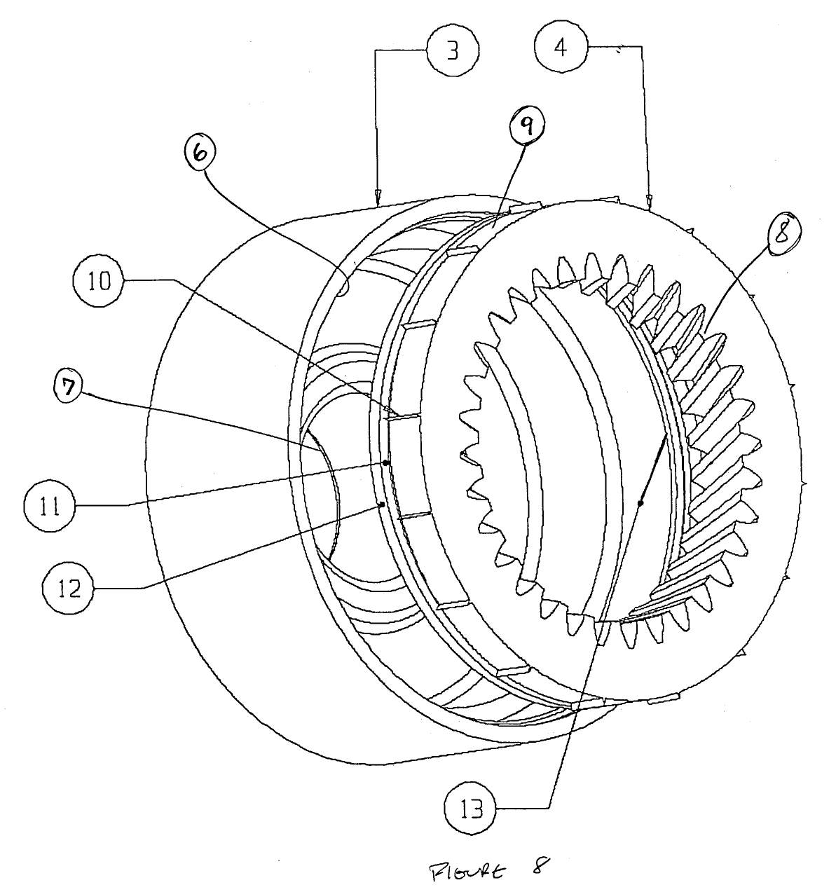

Referring to FIGS. 4-8, the subject invention includes a rotating housing and internal ring gear assembly. The assembly includes an elongated shaft I for rotatably supporting a housing 3. A bushing 2 is seated between the shaft 1 and housing 3 for limiting friction between the rotating housing 3 and the shaft 1. The housing 3 is preferably made of aluminum, but could also be made of magnesium, plastic or other cast, molded or forged material without varying from the scope of the invention. The housing 3 is generally cylindrical and includes an inner cylinder wall 6 and center bore 7 for receiving the shaft 1 and bushing 2 therethrough. The assembly further includes a powder metal ring gear 4 having an internal spline or set of gear teeth 8 and an external circumferential wall 9. A plurality of equally spaced apart external broach teeth 10 project radially outwardly from the external wall 9 for engagement with the inner wall 6 of the housing 3. A cavity or trough 11 is recessed in the external circumferential wall 9 immediate adjacent one end of the teeth 10. Finally, a pilot rim 12 extends around the lower portion of the external wall 9 for aligning and guiding the gear 4 into the housing 3.

In assembly, the ring gear 4 is axially aligned with the center of the housing 3 within the perimeter of the inner cylinder wall 6. The rotating housing 3 needs to have a specific inner diameter for the distance where the gear 4 is positioned to ensure a close fit between the parts. The gear 4 is pressed axially into the housing 3 and the pilot rim 12 aligns, centers and guides the gear 4 between the inner wall 6 of the housing 3. Once properly aligned, the gear 4 is continued to be press fit axially into the housing 3 whereby the broach teeth 10 cut through and into the inner wall 6 of the housing 3. The material or chips cut out of the housing 3 by the broach teeth 10 are collected in the trough 11 so as to not interfere with the fit between the gear 4 and housing 3 or the function of the gear teeth 8 or rotation of the housing 3 about the shaft 1. Once the gear 4 is fully pressed into the housing 3, a c-clip 5 is positioned in a channel 13 formed in the inner wall 6 to further retain the gear 4 within the housing 3. Therefore, in operation, the rotational torque will be transferred from the gear 4 via the external broach teeth 10 to the rotating housing 3.

It should be appreciated that the gear 4 may be of any other material, such as titanium, so long as it is harder than the housing 3 so that the broach teeth 10 will cut into the housing 3 during assembly. Additionally, an external gear with internal broach teeth could be used whereby the housing would retain the external gear. Further, an internal or external splined ring could also be used in place of the gear.

The invention has been described in an illustrative manner, and it is to be understood that the terminology, which has been used, is intended to be in the nature of words of description rather than of limitation.

Many modifications and variations of the present invention are possible in light of the above teachings. It is, therefore, to be understood that within the scope of the appended claims, the invention may be practised other than as specifically described.

What is claimed is:

1. A housing and gear assembly comprising:
a cylindrical housing having an inner cylindrical wall and a center bore for rotatably mounting said housing on an elongated shaft;
an internal ring gear having a plurality of internal gear teeth, an external circumferential wall and a plurality of spaced apart broach teeth projecting radially outwardly from said external wall for cutting engagement with said internal wall of said housing as said ring gear is press fit into said housing to fixedly and rotationally secure said ring gear to said housing.

2. An assembly as set forth in claim 1 wherein said ring gear further includes a trough recessed in said external wall adjacent said broach teeth for collecting cut portions of said housing during said press fit assembly of said ring gear to said housing.

3. An assembly as set forth in claim 2 wherein said ring gear includes a pilot rim adjacent said broach teeth for aligning and guiding said ring gear between said inner cylindrical wall of said housing.

4. An assembly as set forth in claim 3 further including a c-clip seated in a channel formed in said inner wall of said housing to retain said ring gear within said housing.

5. An assembly as set forth in claim 4 further including a bushing seated between said housing and said shaft for providing rotation therebetween.

6. An assembly as set forth in claim 5 wherein said housing is aluminium.

7. An assembly as set forth in claim 6 wherein said ring gear is powder metal.
